(19) United States
(12) Patent Application Publication
(10) Pub. No.: US 2018/0088838 A1
(43) Pub. Date: Mar. 29, 2018

(54) DISK DEVICE THAT UPDATES WRITE COUNTS OF TRACKS BASED ON A HEAD OFFSET DURING WRITING OF ADJACENT TRACKS

(71) Applicant: KABUSHIKI KAISHA TOSHIBA, Tokyo (JP)

(72) Inventor: Ryuichi SATO, Kawasaki Kanagawa (JP)

(21) Appl. No.: 15/448,531

(22) Filed: Mar. 2, 2017

(30) Foreign Application Priority Data
Sep. 26, 2016 (JP) 2016-187379

(51) Int. Cl. G06F 3/06; G11B 5/02; G11B 5/012; G11B 20/18; G11B 5/596

(52) U.S. Cl. CPC G06F 3/0619; G06F 3/065; G06F 3/0685; G11B 5/59627; G11B 5/02; G11B 5/012; G11B 20/18; G06F 3/0653

(57) ABSTRACT

A disk device includes a magnetic disk, a head configured to write data into the magnetic disk, a memory in which a write count and a offset amount of the head during a write operation are stored for each of a plurality of tracks of the magnetic disk, and a processor. The processor is configured to determine an inner offset and an outer offset of the head with respect to a target track of a write operation, and update the write count for an adjacent inner track of the target track based on the inner offset, and the write count for an adjacent outer track of the target track based on the outer offset.

### CROSS-REFERENCE TO RELATED APPLICATION

This application is based upon and claims the benefit of priority from Japanese Patent Application No. 2016-187379, filed Sep. 26, 2016, the entire contents of which are incorporated herein by reference.

### FIELD

Embodiments described herein relate generally to a magnetic disk device and a method for controlling a magnetic disk device.

### BACKGROUND

A magnetic disk device of one type has a refresh function.

### DESCRIPTION OF THE DRAWINGS

FIG. 1 illustrates a configuration of a magnetic disk device according to an embodiment.

FIG. 2 is a block diagram of functional sections implemented in accordance with execution of firmware loaded to a RAM according to the embodiment.

FIGS. 3A and 3B are examples of an ATI management table.

FIG. 4 illustrates a state where off-tracks have occurred in tracks at a time of writing data therein.

FIG. 5 is a flowchart illustrating an example of operations performed by an ATI processing unit when an off-track has occurred according to the embodiment.

FIG. 6 is a flowchart illustrating an example of a refresh operation performed by the ATI processing unit according to the embodiment.

FIG. 7 is a flowchart illustrating an example of procedures for determining a weighting coefficient.

FIG. 8 is a graph illustrating relational formulas of a Viterbi margin and a write count of an adjacent track.

### DETAILED DESCRIPTION

An embodiment is directed to improving reliability of a magnetic disk device.

In general, according to an embodiment, a disk device includes a magnetic disk, a head configured to write data into the magnetic disk, a memory in which a write count and a offset amount of the head during a write operation are stored for each of a plurality of tracks of the magnetic disk, and a processor. The processor is configured to determine an inner offset and an outer offset of the head with respect to a target track of a write operation, and update the write count for an adjacent inner track of the target track based on the inner offset, and the write count for an adjacent outer track of the target track based on the outer offset.

In the present disclosure, a plurality of expressions is used for to some elements. These expressions are given as an example only and are not intended to deny use of other expressions. Furthermore, elements for which a plurality of expressions is not used may be expressed by other expressions.

Moreover, the drawings are schematic and the relations between thickness and plane dimensions, rates of thicknesses of multiple layers, and the like may differ from actual ones. Furthermore, the relations of dimensions and the rates may differ among the drawings.

### FIRST EMBODIMENT

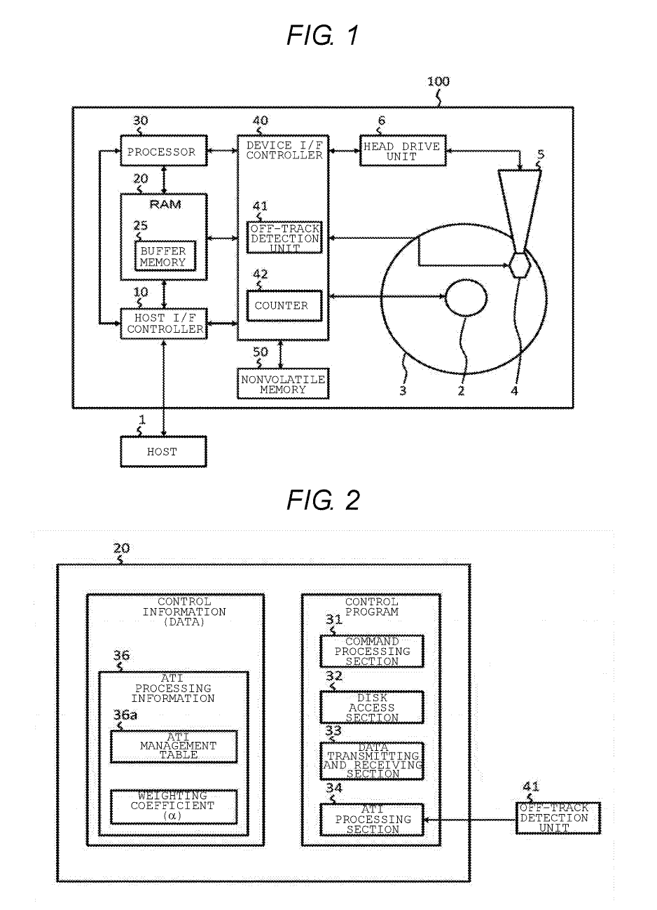

FIG. 1 illustrates a configuration of a magnetic disk device 100 according to an embodiment. The magnetic disk device 100 is known as a hard disk drive (HDD) and connected to a host device 1 (hereinafter, simply “host”), and functions as, for example, an external memory device of the host 1.

The magnetic disk device 100 includes a magnetic disk 3 that is a recording medium rotated by a spindle motor 2. The magnetic disk device 100 also includes a head actuator 5 driven by a head drive unit 6. A magnetic head 4 for write and read operations is attached to a tip end of the head actuator 5.

The magnetic disk device 100 includes, as a control system, a host interface controller (host I/F controller) 10, a RAM 20, a processor 30, a device interface controller (device I/F controller) 40, and a nonvolatile memory 50.

The host I/F controller 10 carries out communication of commands, data, status reports, and the like with the host 1. When receiving a command from the host 1, the host I/F controller 10 notifies the processor 30 of the command. The host I/F controller 10 buffers data received from the host 1 in a buffer memory 25 and transmits the data buffered in the buffer memory 25 to the host 1 in accordance with a control of the processor 30.

The RAM (Random Access Memory) 20 includes a memory area that serves as the buffer memory 25 for temporarily storing data before data from the host 1 are written in the magnetic disk 3. Furthermore, the buffer memory 25 temporarily stores data before data read from the magnetic disk 3 are transferred to the host 1. The RAM 20 also includes a storing area for storing management information for data management. Furthermore, firmware stored in the nonvolatile memory 50 is loaded to the RAM 20. The management information managed by the RAM 20 is backed up in either the nonvolatile memory 50 or the magnetic disk 3. An SRAM (Static Random Access Memory) or a DRAM (Dynamic Random Access Memory), for example, can be used as the RAM 20.

The nonvolatile memory 50 includes a flash memory, an EEPROM (Electrically Erasable Programmable Read Only Memory) or the like, and stores therein the firmware executed by the processor 30. The firmware may be stored in the magnetic disk 3.

The device I/F controller 40 controls the spindle motor 2, the magnetic head 4, and the head drive unit 6 to be driven, thereby writing data in the magnetic disk 3 and reading data from the magnetic disk 3.

The device I/F controller 40 includes an off-track detection unit 41. The off-track detection unit 41 detects an off-track, which is an offset of the magnetic head 4 from a target position in a track width direction, while write processing is being performed on the magnetic disk 3. The off-track detection unit 41 notifies an ATI processing section 34 (see FIG. 2) of a detected write offset amount. The device I/F controller 40 also includes a counter 42. Functions of the counter 42 will be described below.

The processor 30 implements various functions in accordance with execution of the firmware stored in the nonvolatile memory 50. When the magnetic disk device 100 is activated, the firmware stored in the nonvolatile memory 50 is loaded to the RAM 20. The processor 30 executes the firmware load to the RAM 20. The functions implemented by the processor 30 will be described below.

When the host I/F controller 10 receives a write command and write data from the host 1, the processor 30 analyzes the write command and stores the write data in the buffer memory 25. The write data are then read from the buffer memory 25 and input to the device I/F controller 40. The device I/F controller 40 encodes the input write data and drives a write element of the magnetic head 4, thereby writing the encoded write data to the magnetic disk 3. During this write operation, the device I/F controller 40 controls the head drive unit 6 and the spindle motor 2 to write the write data to a target track indicated by the command.

On the other hand, when the host I/F controller 10 receives a read command from the host 1, the processor 30 analyzes the read command. The processor 30 then issues an instruction to the device I/F controller 40 based on an analysis result. As a result, the device I/F controller 40 drives the magnetic head 4 to cause a read element of the magnetic head 4 to read a signal. The device I/F controller 40 demodulates the read signal into read data. Furthermore, the read data are decoded and then buffered in the buffer memory 25. The host I/F controller 10 then transfers the read data to the host 1.

FIG. 2 is a block diagram illustrating functional sections that are implemented in accordance with execution of the firmware (control program) loaded to the RAM 20. The control program includes a command processing section 31, a disk access section 32, a data transmitting and receiving section 33, and the ATI processing section 34, and functions as a controller of the magnetic disk device 100. The command processing section 31 analyzes the command received from the host 1 and notifies the disk access section 32 and the data transmitting and receiving section 33 of an analysis result. The disk access section 32 controls the device I/F controller 40 based on the analysis result of the command, whereby the device I/F controller 40 controls the spindle motor 2, the magnetic head 4, and the head drive 6 to perform a read or write operation on the magnetic disk 3. The disk access section 32 executes management-information update processing in response to the write operation on the magnetic disk 3. The data transmitting and receiving section 33 controls the host I/F controller 10 and the device I/F controller 40 to control data transfer between the magnetic disk 3 and the host 1 via the buffer memory 25.

In FIG. 2, the ATI processing section 34 carries out anti-ATI processing using ATI processing information 36. The ATI processing information 36 contains an ATI management table 36a and a weighting coefficient α (fixed value).

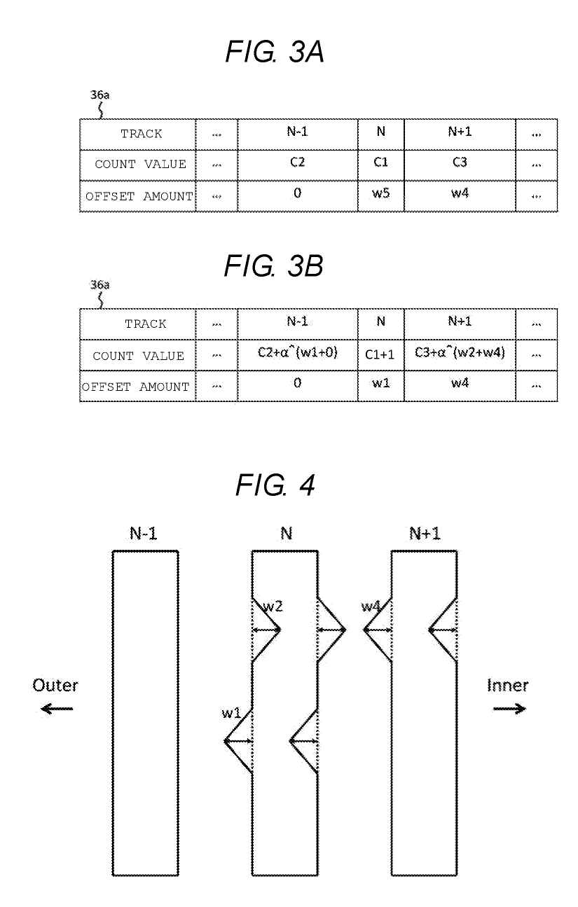

FIGS. 3A and 3B are examples of the ATI management table 36. FIG. 3A illustrates an example of the ATI management table 35 before write processing on a certain track (N), and FIG. 3B illustrates an example of the ATI management table 35 after completion of the write processing on the certain track (N). Each of count values shown in FIGS. 3A and 3B indicates a write count of each track. In the ATI management table 36a according to the present embodiment, a write count to which the weighting coefficient α is and a write offset amount are managed for every track. The count values are counted by the counter 42 of the magnetic disk device 100. While the counter 42 is provided in, for example, the device I/F controller 40, the location of the counter 42 is not limited to the device I/F controller 40.

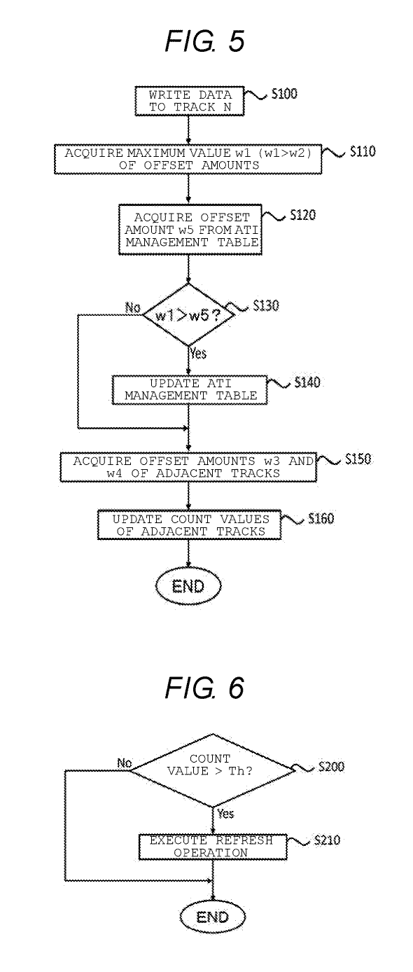

Furthermore, FIG. 4 illustrates a state where off-tracks have occurred in tracks at a time of writing data therein. FIG. is a flowchart illustrating an example of operations performed by the ATI processing section 34 when an off-track has occurred, in accordance with the present embodiment. The operations performed by the ATI processing section 34 will be now described with reference to FIGS. 3A, 3B, 4, and 5. The ATI processing section 34 determines whether an off-track has occurred in a track (N) (first track, write target track) based on an output from the off-track detection unit 41.

It is assumed herein, as shown in FIG. 3A, that count values of tracks (N−1, N, and N+1) prior to writing of data to the track (N) are C2, C1, and C3, respectively, and that offset amounts of the respective tracks are w3(=0), w5, and w4.

The operations performed by the ATI processing section 34 will be described, assuming that out of the tracks adjacent to the track (N), the write offset amount of the outer-side adjacent track (N−1) (second track, outer track) is w3 and the write offset amount of the inner-side adjacent track (N+1) (third track, inner track) is w4. Furthermore, the operations performed by the ATI processing section 34 will be described, assuming that the write offset amount w3 of the outer-side adjacent track (N−1) as zero (w3=0), as shown in FIGS. 3A, 3B, and 4.

The ATI processing section 34 writes data in the track (N) (S100). When completed the write processing in S100, the ATI processing section 34 acquires a write offset amount that has occurred during the write processing (S110). It is assumed herein, as shown in FIG. 4, when the data are written in the track (N) in the processing of S100, an off-track (write offset) w1 in an outer direction and an off-track (write offset) w2 in an inner direction have occurred in the track (N). At this time, it is assumed that a relation between w1 and w2 satisfies w1>w2.

Next, the ATI processing section 34 acquires the write offset amount w5 stored in the ATI management table 36a (S120) and compares w1 with w5 with respect to a magnitude relation. In other words, the ATI processing section 34 determines, for example, whether w1>w5 is satisfied (S130).

If w1>w5 is satisfied in S130 (S130: Yes), the ATI processing section 34 updates the ATI management table 36a (S140). More specifically, the ATI processing section 34 changes (overwrites) the write offset amount w5 stored in the ATI management table 36a to (with) the new write offset amount w1 acquired in S110.

On the other hand, if w1≦w5 is satisfied in S130 (S130: No), the ATI processing section 34 proceeds to processing in 5150. Namely, if w1≦w5 is established, the ATI processing section 34 does not change the write offset amount w5 stored in the ATI management table 36a.

Next, the ATI processing section 34 acquires the write offset amounts w3 and w4 of the tracks (N−1 and N+1) adjacent to the data-written track (N) (S150).

Furthermore, the ATI processing section 34 updates the count values of the adjacent tracks (N−1 and N+1) counted by the counter 42. In one example of the present embodiment, as shown in FIGS. 3A and 4, data are written in the outer-side adjacent track (N−1) with the write offset amount 0, and data are written in the inner-side adjacent track (N+1) with the write offset amount w4. If data are written in the track N with the offset value w1 on an outer side and the offset w2 on the inner side, the count value of the outer-side track becomes C2+α̂ (w1) and the count value of the inner-side track becomes C3+α̂(w2+w4).

Namely, according to the present embodiment, if an offset has occurred in the track (N) at the time of writing of data thereto, the ATI management table 36a is updated in such a manner that the offset amount of the track (N) is a maximum value, as described above. Moreover, the ATI management table 36a is updated in such a manner that write counts to which the weighting coefficient α is applied are added to the count values of the adjacent tracks (N−1 and N+1), respectively.

As described so far, according to the present embodiment, the magnetic disk device 100 is configured such that the ATI management table 36a stores the count values and the offset amounts of the respective tracks. As a result, it is possible to store the write counts which are weighed in accordance with the write offset amounts of the adjacent tracks as the count values.

FIG. 6 is a flowchart illustrating an example of a refresh operation performed by the ATI processing section 34 according to the present embodiment. The operation performed by the ATI processing section 34 will be described with reference to FIG. 6.

The ATI processing section 34 compares the ATI count value of each track registered in the ATI management table 36a with a predetermined threshold Th (S200). In other words, the ATI processing section 34 determines, for example, whether the ATI count value is greater than the predetermined threshold Th.

If the count value >Th is satisfied in S200 (S200: Yes), the ATI processing section 34 executes the refresh operation (S210). Namely, the ATI processing section 34 executes the refresh operation only on the track that satisfies (count value)>Th out of the tracks. In the refresh operation, the ATI processing section 34 reads data from the track to be refreshed and rewrites the read data in the same track.

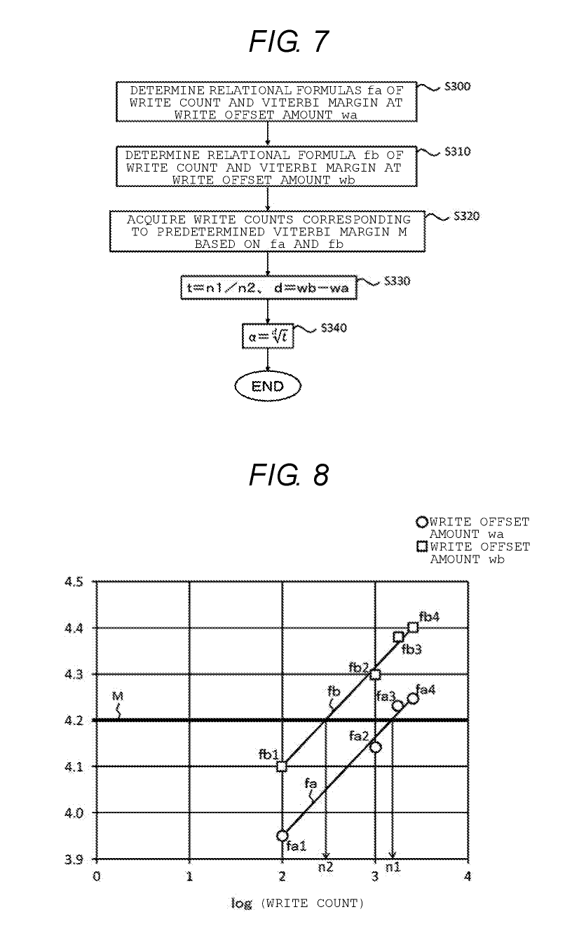

FIG. 7 is a flowchart illustrating an example of procedures for determining the weighting coefficient α. First, the ATI processing section 34 determines a relational formula fa of write quality information on the adjacent track that is either the track (N+1) or the track (N−1) and the write count thereof when the write offset amount of the track (N) is a certain value wa (S300). For example, a Viterbi metric margin or an error rate is employed as the write quality information. The Viterbi metric margin will be referred to as simply “Viterbi margin” in the subsequent description.

The Viterbi margin is a numerical expression of a rate of selecting a value other than a value selected as an optimum value by a Viterbi detection method and is a value directly linked to the error rate. Likewise, the ATI processing section 34 determines a relational formula fb of the write quality information on the adjacent track and the write count thereof when the write offset amount is a certain value wb (wb>wa) (S310).

FIG. 8 is a chart illustrating the relational formula fa of the Viterbi margin and the write count of the adjacent track at the write offset amount wa and the relational formula fb of the Viterbi margin and the write count of the adjacent track at the write offset amount wb. The write count on a horizontal axis is a logarithmic axis. For example, when the write offset amount is wa, the Viterbi margin corresponding to each write count value is experimentally measured while the write count is changed to a plurality of different values. By determining an approximation expression of a plurality of measurement values fa1, fa2, fa3, and fa4 obtained as described above, the relational formula fa is acquired. Likewise, by determining an approximation of a plurality of measurement values fb1, fb2, fb3, and fb4, the relational formula fb is acquired.

Referring back to FIG. 7, the ATI processing section 34 acquires write counts n1 and n2 corresponding to a predetermined Viterbi margin M based on the relational formulas fa and fb, respectively (S320). As shown in FIG. 8, the predetermined Viterbi margin value M may be an arbitrary value as long as the value can cross both the relational formulas fa and fb. Next, the ATI processing section 34 acquires a ratio t (=n1/n2) of n1 to n2. The ATI processing section 34 also determines a difference d (=wb-wa) between the write offset amount wa and the write offset amount wb (S330). The ATI processing section 34 calculates a d-th root of t and determines the weighting coefficient α (S340).

In this way, according to the present embodiment, the ATI count value and the write offset amount are managed for every track, a weighting value that increases exponentially in response to the write offset amount is calculated, and this weighting value is added to a weighted value of any of the adjacent tracks. As a result, refresh processing based on the ATI count value is executed at appropriate timing, and thus it is possible to prevent a read error caused by a write offset.

In the above embodiment, the write count value for weighting is calculated based on the maximum value of the write offset amounts. Alternatively, the write count value may be calculated using an average value of the write offset amounts of the track (N).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

What is claimed is:

1. A disk device comprising:
a magnetic disk;
a head configured to write data onto the magnetic disk;
a memory in which a write count and an offset amount of the head during a write operation are stored for each of a plurality of tracks of the magnetic disk; and
a processor configured to
determine an inner offset and an outer offset of the head with respect to a target track of a write operation, and
update the write count for an adjacent inner track of the target track based on the inner offset, and the write count for an adjacent outer track of the target track based on the outer offset.

2. The disk device according to claim 1, wherein
the processor is further configured to update the offset amount of the target track to a larger value of the inner offset and the outer offset, when the larger value is greater than the offset amount of the target track stored in the memory.

3. The disk device according to claim 1, wherein
the processor is further configured to carryout a refresh operation of rewriting data stored in a track when the write count of the track, which is stored in the memory, is greater than a threshold.

4. The disk device according to claim 1, wherein
the write count for the adjacent inner track is updated by incrementing an amount calculated based on a weighting coefficient, the offset amount of the adjacent inner track stored in the memory, and the determined inner offset, and
the write count for the adjacent outer track is updated by incrementing an amount calculated based on the weighting coefficient, the offset amount of the adjacent outer track stored in the memory, and the determined outer offset.

5. The disk device according to claim 4, wherein
the processor is further configured to calculate the weighting coefficient and store the calculated weighting coefficient in the memory.

6. The disk device according to claim 5, wherein
the processor calculates the weighting coefficient, based on a first relationship between the write count of a track stored in the memory and an error rate for adjacent inner and outer tracks of the track with respect to each of tracks of which offset amount stored in the memory is a first value, and a second relationship between write count of a track stored in the memory and an error rate for adjacent inner and outer tracks of the track with respect to each of tracks of which offset amount stored in the memory is a second value.

7. The disk device according to claim 5, wherein
the processor calculates the weighting coefficient, based on a first relationship between the write count of a track stored in the memory and a Viterbi Metric Margin for adjacent inner and outer tracks of the track with respect to each of tracks of which offset amount stored in the memory is a first value, and a second relationship between the write count of a track stored in the memory and a Viterbi Metric Margin for adjacent inner and outer tracks of the track with respect to each of tracks of which offset amount stored in the memory is a second value.

8. The disk device according to claim 1, wherein
the memory is a volatile memory, and
the processor is further configured to back up data in the memory into the magnetic disk.

9. A method of operating a disk device including a magnetic disk, a head configured to write data into the magnetic disk, and a memory, the method comprising:
storing, in the memory, a write count and an offset amount of the head during write operations for each of a plurality of tracks of the magnetic disk;
carrying out a write operation on a target track of the magnetic disk;
determining an inner offset and an outer offset of the head with respect to the target track; and
updating, in the memory, the write count of an adjacent inner track of the target track based on the inner offset, and the write count of an adjacent outer track of the target track based on the outer offset.

10. The method according to claim 9, further comprising:
updating, in the memory, the offset amount of the target track to a larger value of the inner offset and the outer offset, when the larger value is greater than the offset amount of the target track stored in the memory.

11. The method according to claim 9, further comprising:
carrying out a refresh operation of rewriting data stored in a track, when the write count of the track, which is stored in the memory, is greater than a threshold.

12. The method according to claim 9, wherein
the write count for the adjacent inner track is updated by incrementing an amount calculated based on a weighting coefficient, the offset amount of the adjacent inner track stored in the memory, and the determined inner offset; and
the write count for the adjacent outer track is updated by incrementing an amount calculated based on the weighting coefficient, the offset amount of the adjacent outer track stored in the memory, and the determined outer offset.

13. The method according to claim 12, further comprising:
calculating the weighting coefficient and storing the calculated weighting coefficient in the memory.

14. The method according to claim 13, wherein
the weighting coefficient is calculated based on a first relationship between the write count of a track stored in the memory and an error rate for adjacent inner and outer tracks of the track with respect to each of tracks of which offset amount stored in the memory is a first value, and a second relationship between the write count of a track stored in the memory and an error rate for adjacent inner and outer tracks of the track with respect to each of tracks of which offset amount stored in the memory is a second value.

15. The method according to claim 13, wherein
the weighting coefficient is calculated based on a first relationship between the write count of a track stored in the memory and a Viterbi Metric Margin for adjacent inner and outer tracks of the track with respect to each of tracks of which offset amount stored in the memory is a first value, and a second relationship between the write count of a track stored in the memory and a Viterbi Metric Margin for adjacent inner and outer tracks of the track with respect to each of tracks of which offset amount stored in the memory is a second value.

16. A non-transitory computer readable medium comprising a program that is executable in a computing device to cause the computing device to perform a method for operating a disk device including a magnetic disk, a head configured to write data into the magnetic disk, and a memory, the method comprising:
storing, in the memory, a write count and an offset amount of the head during write operations for each of a plurality of tracks of the magnetic disk;
carrying out a write operation on a target track of the magnetic disk;
determining an inner offset and an outer offset of the head with respect to the target track; and
updating, in the memory, the write count of an adjacent inner track of the target track based on the inner offset, and the write count of an adjacent outer track of the target track based on the outer offset.

17. The non-transitory computer readable medium according to claim 16, wherein the method further comprises:
updating, in the memory, the offset amount of the target track to a larger value of the inner offset and the outer offset, when the larger value is greater than the offset amount of the target track stored in the memory.

18. The non-transitory computer readable medium according to claim 16, wherein the method further comprises:
carrying out a refresh operation of rewriting data stored in a track, when the write count of the track, which is stored the memory, is greater than a threshold.

19. The non-transitory computer readable medium according to claim 16, wherein
the write count for the adjacent inner track is updated by incrementing an amount calculated based on a weighting coefficient, the offset amount of the adjacent inner track stored in the memory, and the determined inner offset; and
the write count for the adjacent inner track is updated by incrementing an amount calculated based on the weighting coefficient, the offset amount of the adjacent outer track stored in the memory, and the determined outer offset.

20. The non-transitory computer readable medium according to claim 16, wherein the method further comprises:
calculating the weighting coefficient and storing the calculated weighting coefficient in the memory.
